(19) United States
(12) Patent Application Publication
(10) Pub. No.: US 2006/0099559 A1
(43) Pub. Date: May 11, 2006

(54) Analysis of pre-cordial thumps for treatment of a cardiac dysrhythmia

(76) Inventors: Peter Kohl, Oxford (GB); Christian Boulin, Heidelberg (DE)

Correspondence Address: NIXON & VANDERHYE, PC, 901 NORTH GLEBE ROAD, 11TH FLOOR, ARLINGTON, VA, 22203, US

(21) Appl. No.: 10/547,847

(22) PCT Filed: Mar. 4, 2004
(86) PCT No.: PCT/GB04/00906

§ 371 Date: Oct. 18, 2005

(30) Foreign Application Priority Data
Mar. 4, 2003 (GB) 03049087

(51) Int. Cl. G09B 23/28

(52) U.S. Cl. 434/265

(57) ABSTRACT

A device for analysing manual thumps, applied to simulate pre-cordial thumps for the treatment of a dysrhythmia of the heart of a patient, has an array of force-detecting, proportional sensors having a frequency response of at least 1 kHz, usually 10 kHz or more. A preferred form of sensor has a key for receiving an applied force mounted for movement relative to a support with a spring having a preselected spring constant coupled therebetween. An optical sensor and grating detect the displacement of the key relative to the support. This sensor provides advantages of being fast, accurate and truly proportional. The device has an electronic circuit for receiving the output signal of each sensor and outputting the output signals to an external computer running a program to analyse and display the output signals. The device may be used to study the biophysical parameters of a pre-cordial thump or as a teaching tool to train users in the correct application of a pre-cordial thump. The device may also be used to analyse similar impacts in other technical fields.

The present invention relates to a device for the detailed analysis of biophysical parameters involved in the application of a fist thump of the kind used as a pre-cordial thump (PT) for treatment of cardiac dysrhythmias.

Cardiac dysrhythmia, that is abnormal rhythmicity of heartbeats, includes states where the heart beats too slowly (bradycardia) or too frequently (tachycardia) for adequate maintenance of blood circulation. For the purpose of this simplified classification, asystole (the absence of a regular heart beat) may be thought of as an extreme bradycardia, while fibrillation (ill-coordinated contraction of individual cardiac muscle fibres, resulting in the lack of effective contraction of cardiac chambers) may be regarded as an extreme form of tachycardia. Ventricular asystole and ventricular fibrillation are both fatal unless promptly terminated by conversion to rhythmic and coordinated contraction of myocardium (cardioversion).

There are between 250,000 and 300,000 cardiac arrests annual in the United States, and about 80,000 to 100,000 in each of the United Kingdom and Germany. The success of interventions for cardioversion is on average around 40% to 60% of cardiac arrests and depends to a large extent on the delay between the onset of the cardiac dysrhythmia and the application of resuscitatory measures.

Of the techniques used for cardioversion from either asystole or tachycardic dysrhythmias including ventricular fibrillation, PT is the most immediately, and the most widely, available intervention. Furthermore, it is the intervention which is least dependent on the surrounding environment: PT typically involves the application of a brisk impact with the ulnar surface of the clenched fist to the precordium of a patient, who would be usually in a supine position, from a height of about 30 cm followed by active swift retraction of the fist. As such, PT does not require any equipment or apparatus and is therefore instantly available in any setting, including field conditions.

It is important to note that PT is very different from external cardiac massage, which is a more slowly occurring rhythmic application of force to the precordium (maintained over hundreds of ms) with the aim of deforming the precordium in such a way as to cause expulsion of blood from the heart by compression of cardiac chambers, afforded by the progressive approximation of anterior and posterior chest walls. PT, in contrast, is applied as a single (or repeated) swift impulse-like blow to the precordium, reaching its peak mechanical impact characteristics within a time course of less than 100 ms, typically below 10 ms, and often below 5 ms, followed by active, swift removal of the fist from the patient's chest.

The resuscitatory potential of PT has been known for nearly one century. In 1920, it was reported that ‘thumping’ the chest of Stokes-Adams patients in ventricular standstill stimulates competent cardiac contraction. It has, since, repeatedly been confirmed that PT initiate beats in asystolic hearts, and that this procedure can be applied repeatedly (in which case it sometimes called ‘pre-cordial percussion’) to reliably maintain circulation and consciousness in patients during prolonged periods of ventricular standstill.

PT has also been used to revert ventricular tachycardia and even early ventricular fibrillation. Effectiveness of mechanical cardioversion varies, depending on the character of dysrhythmia, with about one third of ventricular tachycardia patients being responsive. In all reported cases of mechanical cardioversion of ventricular fibrillation, PT was applied very early in the development of fibrillation, either at the verge of deterioration of ventricular tachycardia into ventricular fibrillation, or within the first 5 to 15 seconds after the onset of ventricular fibrillation, as verified by ECG and occasionally arterial pressure recordings.

Although the precise mechanisms underlying these mechanical effects on the cardiac rhythm are not entirely understood, it is believed to be as follows. In general, diastolic stretch depolarises resting cardiac cells and tissues. This may be accounted for by mechanical operation of stretch-activated ion channels in the membranes of cardiac cells, which would explain why stretch-induced reactions can also be seen in heart transplant recipients, isolated hearts and tissues, or even isolated cardiac cells. A popular illustration of these intra-cardiac effects of mechanical stimulation is the observation that volume pulses of sufficient amplitude, caused by fluid injection into a left ventricular balloon, may pace an otherwise quiescent ventricle in an isolated (i.e. denervated) Langendorff rabbit heart preparation. The depolarising effect of stretch on resting cardiac tissue explains the clinical observations of efficient cardiac pacing by PT in asystolic hearts, because the mechanical stimulation depolarises resting myocardial tissue towards threshold for excitation and triggers contraction. Mechanical cardioversion of ventricular tachycardia or early ventricular fibrillation is a more complex phenomenon, but one possible mechanism is that supra-threshold mechanically induced depolarisation of the resting proportions of myocardium interrupts the pathway for dysrhythmic excitation by synchronously exciting large areas of the heart, subsequently rendering the myocardium non-excitable and thereby terminating certain types of dysrhythmias, such as re-entrant electrical activity, for example.

At present, PT is the first prescribed procedure of the Advanced Cardiac Life Support (ACLS) Algorithm for witnessed cardiac arrest, even though the procedure itself is not described in detail in the algorithm. Since its inclusion into the very first edition of ACLS Algorithms, the use of PT has progressively been de-emphasised. There are several reasons for this trend. This includes an uncertainty about applicability to various types of arrhythmia and related success rates (reported cardioversion rates by PT vary from 6% to 93%) and potentially detrimental side effects of the procedure, even though these are understood to be well below 1%.

None of the available studies provide a quantitative description of the biophysical parameters of PT. This makes it impossible to interrelate observations. The lack of insight into the biophysics of PT makes it also impossible to develop a universal teaching guide, or better even, training aids for the teaching of PT. All of this re-enforces a situation where PT is applied in no uniform manner, yielding highly variable cardioversion rates, with little prospect of optimising the clinical utility of the procedure, or its training.

According to the present invention, there is provided a device for analysing manual thumps applied to simulate pre-cordial thumps for the treatment of a dysrhythmia of the heart of a patient, the device comprising a sensor arrangement for detecting biophysical parameters of a said manual thump.

Accordingly, the present invention provides a device which makes it possible to detect parameters of a manual thump of the type used as a pre-cordial thump for the treatment of cardiac dysrhythmia This allows such manual thumps to be analysed. Thus, various types of device in accordance with the present invention may be used as (1) an investigative tool to study the biophysics of fist thumps such as sed for PT, and (2) a simple yet effective teaching aid for the application of PT.

Firstly, a device in accordance with the present invention may be used to investigate fist thump biophysics in a detailed quantitative manner in order to establish a detailed and universally applicable description of the procedure.

An international survey currently being performed by one of the inventors and his team shows a striking difference in the clinical utility of PT between the US and the United Kingdom, with the success rate in the US being about three-fold higher than in the UK. The reasons for this discrepancy are still under investigation, but early data (reporting on over 1,200 cases of PT) show that US medical personnel rank ventricular tachycardia as their prime indication for application of a chest thump, whereas the focus in the UK is on ventricular fibrillation. The higher success rate in the US serves to emphasise the desirability of applying mechanical cardioversion during the early development of serious dysrhythmias. Furthermore, the study illustrates relatively good results with the application of PT in asystole.

This raises the need to provide more substantive information on PT in the context of dysrhythmia treated, in particular since the current ACLS Algorithms focus exclusively on cardiac arrest, whereas ventricular tachycardia may be a most appropriate target for the intervention.

An alternative explanation for differences in clinical outcome between UK and US could be related to a national bias in the biophysics of PT application, for example if US medical personnel might hit more or less forcefully, swiftly and/or deeply. This should be investigated, and the proposed device is designed to accomplish this task.

In this context, it is very important to realise that a full study of PT biophysics would extend beyond the investigation of total impact energy, or peak force (which is a function of the deceleration pathway length), as other biophysical parameters, such as the dynamic impact properties (time-to-peak, duration of impact, etc.), pressure distribution (contact area dependent) or impact power (a function of deceleration time), may be key determinants of PT outcome. Therefore, various of the preferred features described in more detail below are designed to provide information on such other parameters.

Secondly, a device in accordance with the present invention may be used for training of ACLS certified personnel in the application of PT. For this, a set of optimal parameter ranges will be established from recordings taken from medical personnel with high success rates in mechanical cardioversion by PT. Key parameters will be identified and optimal ranges for PT defined. The built-in logic controller of the device will subsequently provide immediate feedback, via suitable integrated display, on the optimal performance of PT.

The proposed device for use as a teaching aid may be a stand-alone solution, with built-in indicators for PT parameter feedback, or used in the context of a more detailed PC-based data analysis and display system, to guide self-training, PT impact optimisation, and research. In general, it is not necessary for the teaching aid to provide as much detailed information on all the parameters of the parameters of the thump as the investigative device discussed above. Therefore, the preferred features described below, whilst advantageous, are less important in such a teaching aid.

Desirably, the device, particularly when used as a teaching aid, has means for analysing the detected parameters according to predetermined criteria to classify the effectiveness a manual thump and/or means for outputting a visual and/or audible indication of the detected parameters, to provide feedback to the user to allow improvement in their technique for applying a manual thump.

Preferred features of the device will now be described.

The device may comprise at least one sensor having a frequency response of at least 1 kHz.

Provision of such a fast frequency response sensor allows the device to detect variation of the parameters of the manual thump over time, given that the impulse of a typical manual thump is of the order of tens of milliseconds, typically with a rise time of the order of 5 ms or less and a total period of the order of 10 to 20 ms. The frequency response of 1 kHz is just about sufficient, particularly in a device used as a teaching aid, but more preferably the frequency response is at least 2, at least 5 or at least 10 kHz. A frequency response of 10 kHz provides a resolution of the order of 0.1 ms which provides full characterisation of the variation of the detected parameters over the time of the impact. Higher frequency responses of say 20 or 100 kHz provide greater detail.

The sensor arrangement may comprise at least one force-detecting sensor.

With such a sensor, the output signal of the sensor is representative of the force applied to the sensor, not dependent on the area of the sensor to which the impact is applied as in a pressure-detecting sensor. That being said, in context of the present invention, a pressure-detecting sensor may effectively act as a force-detecting sensor if the sensitive area of the sensor is sufficiently small compared to the impact area of the thump.

Preferably, the output of the sensor arrangement is proportional to the mechanical input, at least in the frequency range of interest.

A proportional sensor is one in which the output signal is directly proportional to the sensed parameter, i.e. the output signal is not significantly affected by the first-order derivative of the sensed parameter with time, as occurs in a differential sensor. Use of a proportional sensor allows proper characterisation of the relevant biophysical parameters of the manual thump and is therefore particularly important when the device is used as an investigative tool.

The sensor arrangement may use a sensor or sensors of any suitable type, for example including, but not limited to, piezo-electric material, optical transducers, or resistive sensors such as those employing mechano-sensitive resistive coatings with appropriate inter-digitised electrodes.

However, a preferred form of sensor comprises at least one sensor which comprises: a support; a member for receiving an applied force mounted for movement relative to the support with a resilient arrangement having a preselected spring constant coupled between the member and the support; an optical sensor for detecting the displacement of the member relative to the support.

In such a sensor, preferably the optical sensor is fixed to one of the support and the member, and an optical grating is fixed to the other of the support and the member positioned to be analysed by the optical sensor to detect the displacement of the member relative to the support.

Such an opto-mechanical sensor provides a number of significant advantages when applied as a sensor for a device in accordance with the present invention. The use of an optical sensor, in particular in combination with an optical grating, allows very accurate detection of displacement. The output of such a sensor is typically a digital signal which is of advantage for computerised data processing. Since the displacement is related to the applied force by the spring constant of the resilient arrangement, the detected displacement is representative of the applied force. The accuracy of the detected displacement creates a similarly high accuracy in the force detection. The opto-mechanical sensor is also fast and easily adjustable. The high response time of the optical sensor means that the opto-mechanical sensor is truly proportional within the frequency range of interest for manually applied thumps.

Whilst these benefits of the opto-mechanical sensor are particularly advantageous for use in a device in accordance with the present invention, the opto-mechanical sensor is expected to be similarly advantageous as a force-detecting sensor for detecting other impacts. Therefore, in accordance with a further aspect of the present invention, there is provided the opto-mechanical sensor per se.

Another benefit of the opto-mechanical sensor is that the resilient arrangement may be selected to have mechanical properties which simulate the precordial regional of the chest of a patient. In combination therewith, the detected displacement allows analysis of the deceleration pathway length, which is a relevant parameter of the manual thump which it is desirable to study. This deceleration pathway may be of any length as desired by the user but in the context of pre-cordial thumps is typically in the range from 0.5 cm to 10 cm, preferably in the range from 4 cm to 6 cm.

The device may further comprise a speed detector arrangement for detecting the pre-impact speed of the fist.

Such a speed detector arrangement provides two distinct advantages. Firstly, the detected pre-impact speed is an additional parameter of the manual thump which may be used in analysis of the thump, together with the parameters detected by the sensor arrangement. Secondly, the output of the speed detector arrangement may be used as a trigger signal to start recording of the output of the sensor arrangement. This avoids the need for continuous monitoring of the sensor arrangement which would increase the circuit scale by increasing the buffering or memory requirement for recording the output signals and would increase power consumption.

The speed sensing of the initial fist approach may be either measured using an optical transmitter/receiver pair at the predetermined distance from the sensor arrangement, or preferably plural optical transmitter/receiver pairs spaced apart by a predetermined amount or amounts. Such optical transmitter/receiver pairs are preferably arranged within 2 cm, or better still 1 cm, of the sensor arrangement so that they are in the final part of the pre-impact fist pathway and thus provide highly accurate pre-impact speed data.

Alternatively, the movable member could be loaded with two separate springs of different spring constant, arranged so that the stiffer spring engages the movable member after a predetermined amount of movement after the point when the less stiff spring engages the movable member. Thus, the initial movement is conducted against a relatively compliant spring, preferably just strong enough to lift the target platform against gravity to its pre-impact zero position. This approach allows the pre-impact speed to be determined from the detected movement during the predetermined amount of movement in which the less stiff spring engages the movable member. This approach would have the advantage that no additional optical sensors would be required, thereby reducing complexity of the system, weight, and control circuitry demands, while still offering a good estimate of fist speed at the beginning of the impact. Such an implementation would be particularly useful for a training device, which should be a simple as possible and as accurate as necessary to provide suitable feedback to personnel training the precordial thump. The predetermined amount of movement is preferably at least 0.5 mm, more preferably at least 1 mm. The predetermined amount of movement is preferably at most 3 mm, more preferably at most 2 mm.

Preferably, the sensor arrangement comprises an array of sensors.

The use of an array of sensors provides for detection of the location and distribution of the applied force. This provides additional information which is useful in two ways. Firstly, it allows study of the accuracy of the applied thumps, for example by comparing the actual location of the impact with a target location of the impact. Secondly, it allows analysis of how the spatial distribution varies for different users, for example due to their thumping technique or the physiological structure of the part of their fist applying the thump.

In general, the number of sensors in the array may take any value. It is desirable to include a sufficient number of sensors with respect to the size of a fist to give enough information on the area and location of the impact. However, this must be balanced with the need to keep the number of sensors as low as possible, due to the cost in terms of circuit scale and processing power needed to process the output signals with consequent increase in the expense, size and power consumption of the device.

The array may be a regular array, or may be irregular, for example by having a higher density of sensors in a target region than elsewhere.

The device will typically include an electronic circuit for receiving the output signal of each sensor, preferably including at least one analog-to-digital converter arranged to convert the output signals of the sensors into a digital signal, if the sensors produce analog output signals.

Advantageously, the electronic circuit further comprises at least one multiplexer arranged to time-division multiplex the output signals of a group of sensors. If the output signals of the sensors are analog, the multiplexer may be arranged before said at least one analog-to-digital converter.

By multiplexing together the output signal of a group of sensors, it is possible to reduce the scale and power consumption of the electronic circuit which in turns allows the device to be compact and have a more compact and/or lasting battery.

The device may be connected to a computer system arranged to receive the output signals of the sensors and to process those output signals by a computer program running on the computer system. For example, the computer program may produce a graphical representation of the output signals of the sensors.

In accordance with a further aspect of the present invention, there is provided such a computer program per se.

The device in accordance with the present invention has been designed to study manual thumps of the type which would be applied as a precordial thump for the treatment of a dysrhythmia. However, it is expected that the device will be equally useful to study impacts of a similar nature. Therefore, in accordance with a further aspect of the present invention, there is provided the device per se.

To allow better understanding, a device which is an embodiment of the present invention will now be described by way of non-limitative example with reference to the accompanying drawings in which:

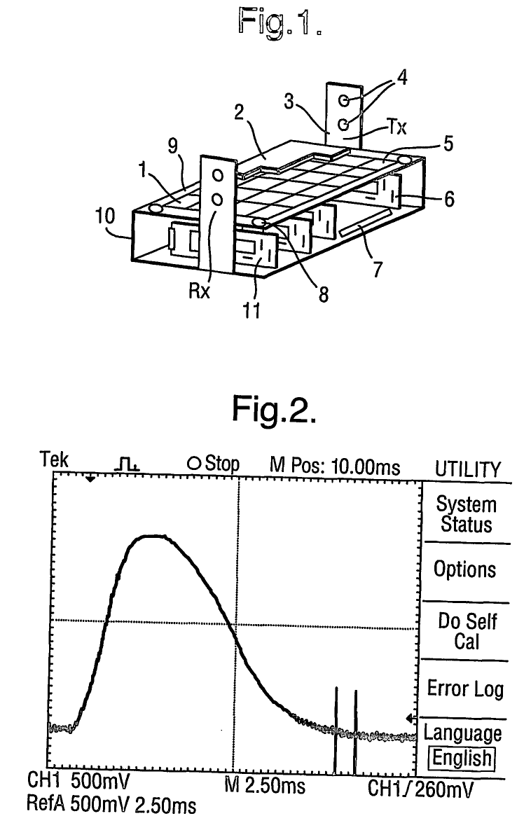

FIG. 1 is a perspective view of the device;

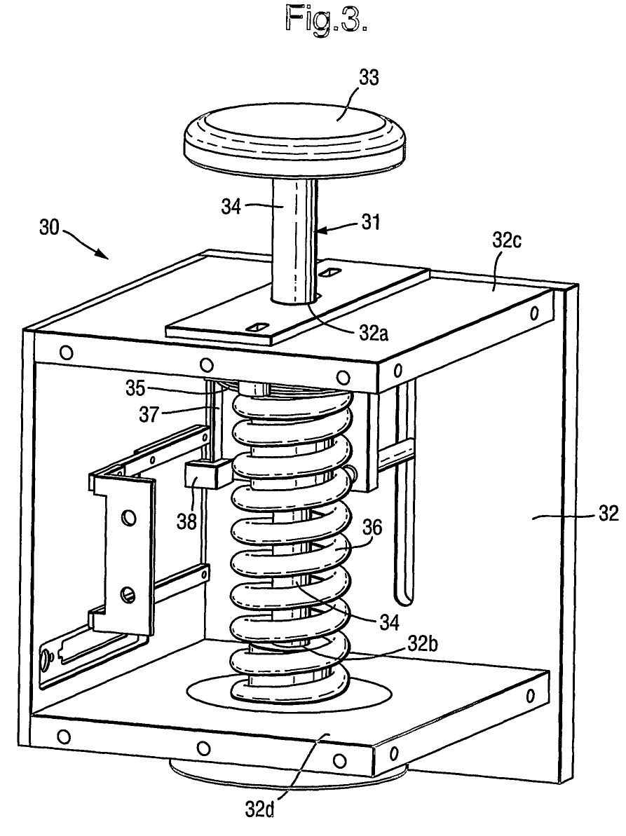

FIG. 2 shows a force recording obtained with a prototype implementation during the course of a fist thump;

FIG. 3 is a perspective view of a sensor which may be used in the device of FIG. 1;

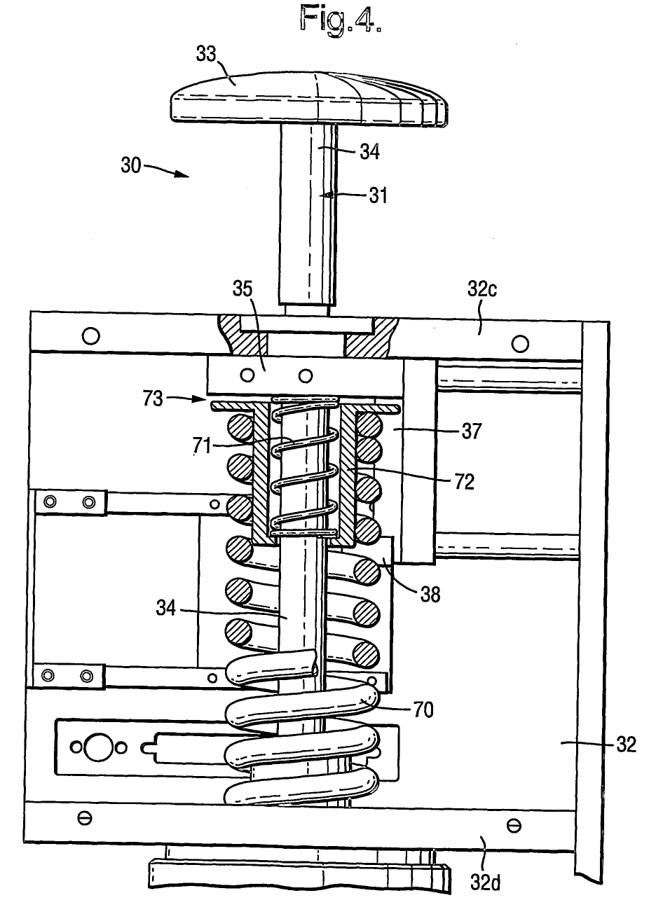

FIG. 4 is a side view of a modified version of the sensor of FIG. 3;

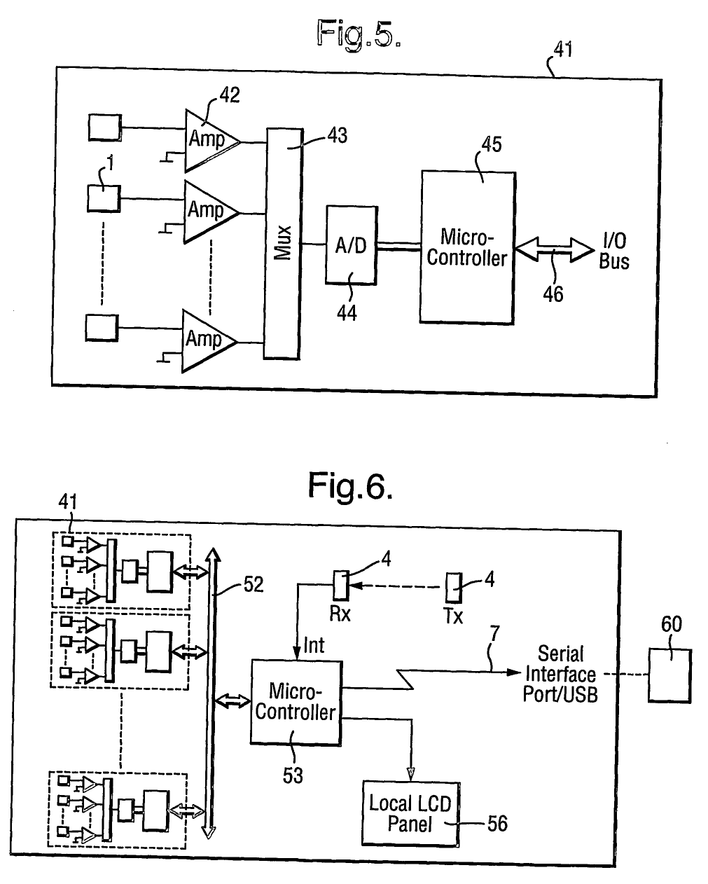

FIGS. 5 and 6 are a functional block diagrams of the electronic circuit of the device; and

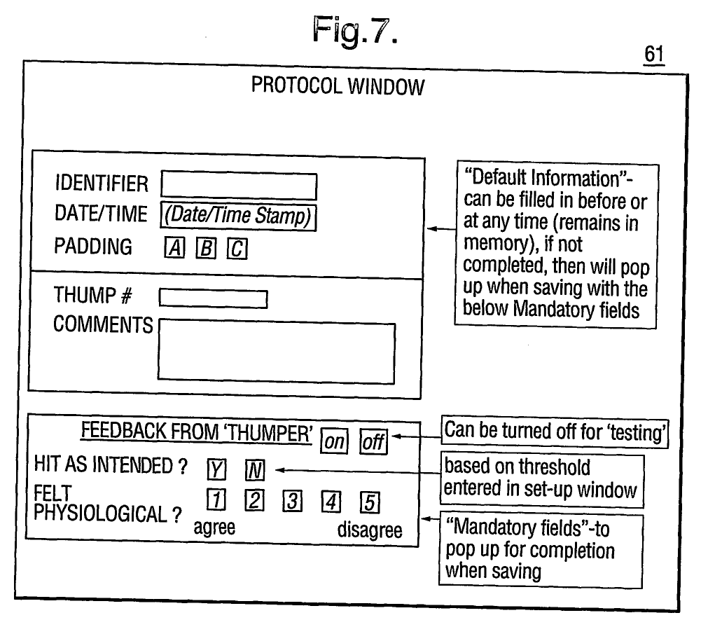

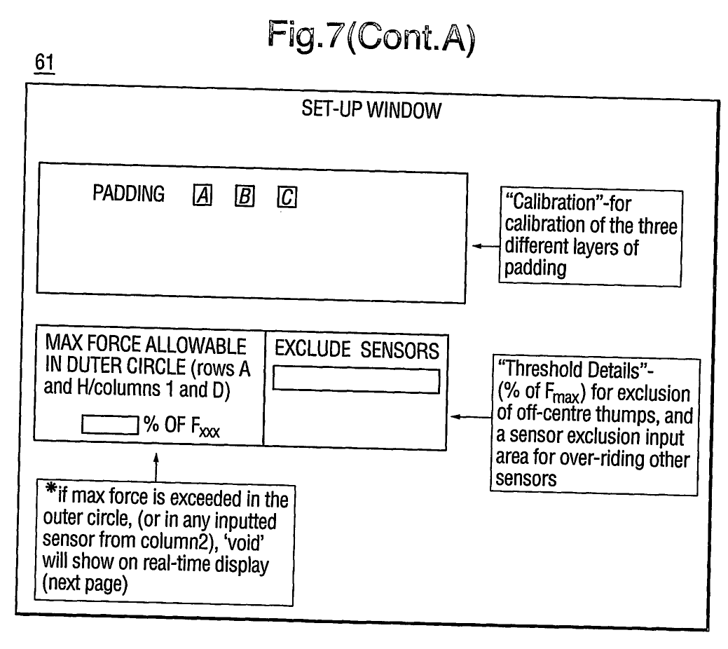

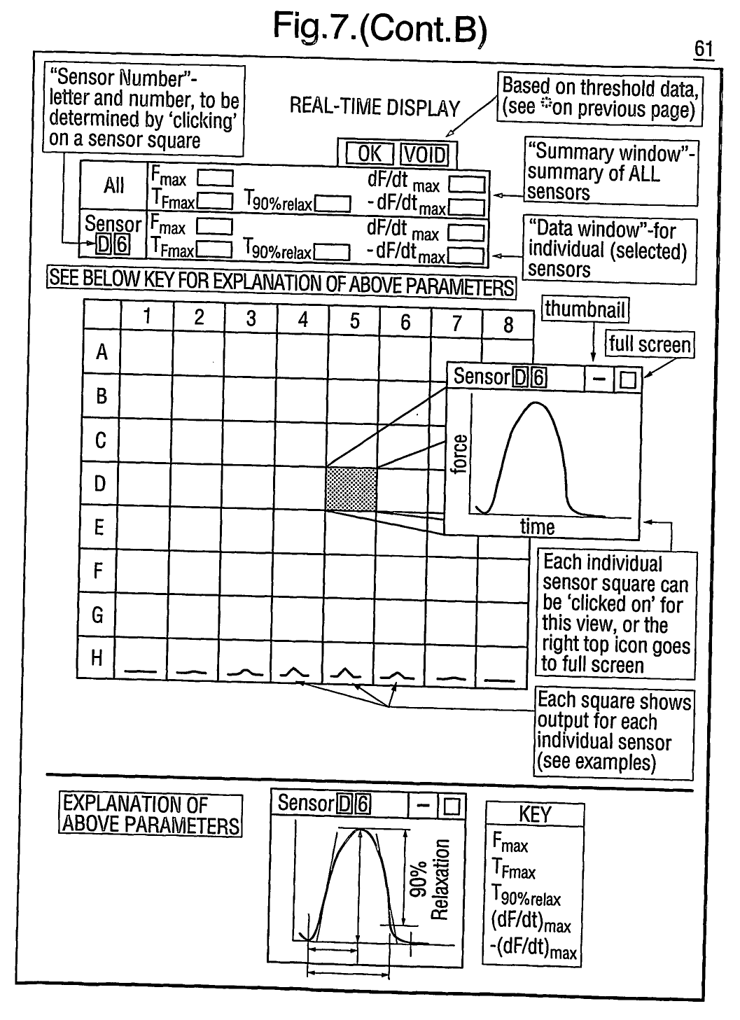

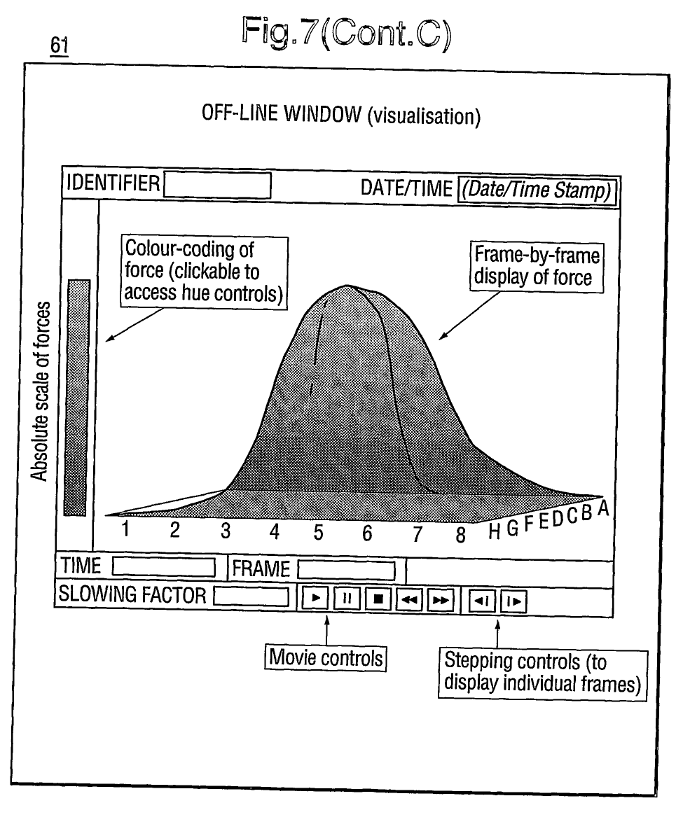

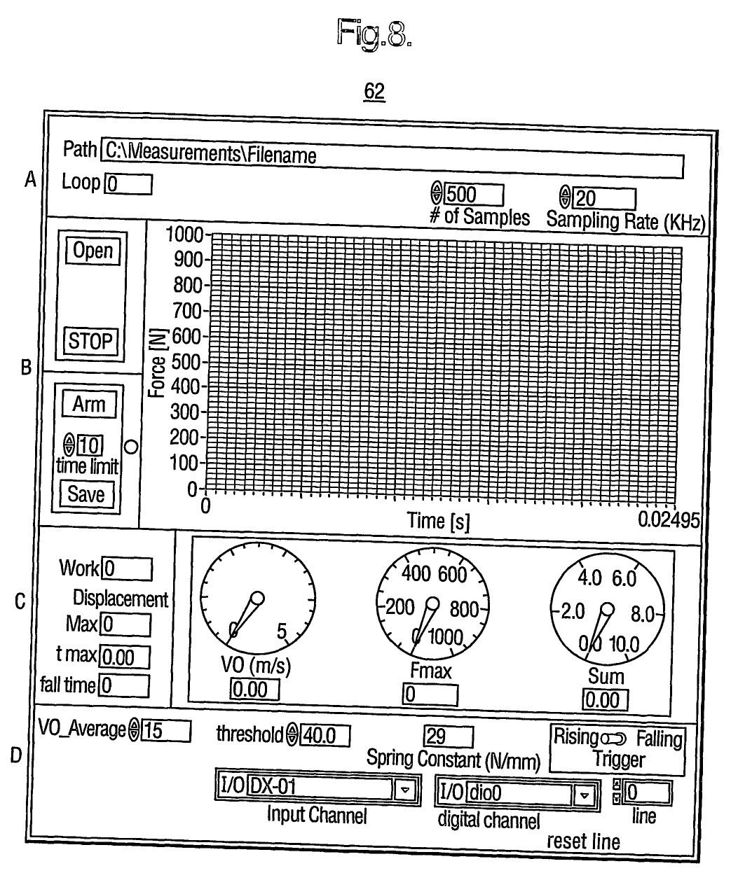

FIGS. 7 and 8 are views of two alternative graphical user interfaces for the device.

A device which is an embodiment of the present invention is illustrated in schematic form in FIG. 1. The device is portable and comprises a sensor arrangement consisting of a regular array of sensors 1 mounted on a sturdy metal plate 9 forming the top part of a housing 10. The sensors 1 of the array cover a target plane of the device for receiving a manual thump. The housing 10 is sufficiently sturdy to receive the impact of a manual thump.

Each sensor 1 is covered by a thin, rigid cap 5 of any appropriate material, such as metal or plastic, arranged in its dimensions and geometry to transmit the applied force of a fist thump to the active surface of each sensor 1. The caps 5 are designed to optimise force transmission from the device surface to the sensors 1 in order to avoid errors in the measurements due to disturbances such as local overload, angled force application, lateral shifting or sliding, etc. The caps 5 are fixed in place by adhesive to maintain them in the correct location over each sensor 1.

On top of this assembly of the sensors 1 and the caps 5, there is a soft cover sheet 2 (shown cut-away in FIG. 1). The cover sheet 2 preferably has a resilience selected to simulate the precordial region of the chest of a human. This allows the device to analyse thumps which mimic precordial thumps applied to an actual patient. The cover sheet 2 may be made of any appropriate material, such as silicone or other polymers, rubber or other material with appropriate mechanical properties. The cover sheet 2 is maintained in position by the use of a number of metal rods (preferably at least four) that fit into corresponding holes 8 machined in the top plate of the housing 10. This solution has the advantage of making it easy to exchange sheets 2 with different mechanical properties to simulate different patient tissue characteristics. Easy exchange of the sheet 8 is also important in the context of device maintenance and overall cleanliness. The sheet 2 may bear a visible target at the physical centre of the array of sensors 1 indicating the desired impact target region.

Opposed sides of the housing 10 carry a respective vertical arm 3, detachable for transport of the device. The arms 3 mount two optical transmitter/receiver pairs 4 each with a transmitter (Tx) on one arm 3 and a receiver (Rx) on the other arm 3. The transmitter/receiver pairs 4 are spaced apart in a direction perpendicular to the impact surface of the array of sensors 1 by an amount sufficient to avoid optical cross-talk (typically about 1 cm to 2 cm). The passage of the fist between the two transmitter/receiver pairs 4 results in the generation of two digital signals. These are supplied to the electronic circuit and used (a) to provide an electronic trigger signal for the start of data acquisition from the force-detecting sensors 1, and (b) to provide an instant reading on the pre-impact speed of fist movement near the target plane, this being a parameter of the thump which it is useful to study.

Inside the housing 10 is an electronic circuit connected to the sensors 10. The electronic circuit, which is described in more detail below, comprises amplifying electronics and analog-to-digital signal converters are mounted on plural, electronic block printed circuit boards 6 and a master control board 11.

The sensors 1 will now be described in more detail.

The sensors 1 in the embodiment illustrated in FIG. 1 are resistive sensors comprising a mechano-sensitive resistive coating with appropriate inter-digitised electrodes. Accordingly the sensors 1 are force-detecting, the output signals of the sensors 1 being representative of applied force. In general, the sensors could be any sensors capable of detecting parameters of the applied impact, for example, but not limited to, piezoelectric sensors or optical transducers. Force-detecting sensors are preferred, but sensors detecting other parameters could be used. An alternative opto-mechanical sensor 30 is described below. As an alternative to the arrangement shown in FIG. 1, there may be only a single sensor 1 or 30.

The dimensions of individual sensors 1 will define maximum spatial resolution of the impact recording array. The density of the sensors 1 may be increased (e.g. in target region in the centre of the device), for example by means of adjusting dimensions of the caps 5.

FIG. 2 illustrated the time-course of the output signal for a typical manual precordial thump applied to a single sensor 1. The impact is impulse-like and time-scales are therefore short. The peak force is typically reached in less than 100 ms, usually below 10 ms, and often in less than 5 ms. In order that the output signals of the sensors 1 properly show the variation of force with time, it is desirable to use sensors 1 that have a fast frequency response of at least 1 kHz, preferably at least 2, 5 or 10 kHz to resolve all the detail of the variation in force over time, ie to allow a dynamic analysis. Also, the electronic circuit should be sufficiently fast to process the output signal without loss of resolution.

Another important characteristics for the sensor 1 is repeatability of impact measurements. This is desirable both to allow daily use without re-calibration and for long-term calibration, best done via comparison of sensor responses to (1) a calibrated static charge and (2) the impact of a falling object of defined mass from a defined height.

As an alternative which may replace the sensors 1 shown in FIG. 1, FIG. 3 illustrates a powerful opto-mechanical sensor 30 that is fast, highly accurate, easily adjustable, and a true proportional force sensor even at high speed impacts, which therefore matches all requirements of the present thump recording system, in particular achieving the fast frequency response mentioned above. Furthermore, this type of sensor uses a movable member to receive the impact, which allows the sensor arrangement to simulate the precordial region of the chest of a patient by selection of the mechanical properties of the movable member. Another advantage of the opto-mechanical sensor 30 is that it produces a digital output. Consequently, the analog-to-digital converter 44 (described in more detail below) is not required when the sensors 1 are replaced by the opto-mechanical sensors 30.

This sensor 30 comprises a member 31 mounted in a support 32 so as to be reciprocally movable relative to the support 32. The member 31 comprises a plate 33 which in use receives applied force from impacts of fist thumps, and a rod 34 which extends away from the plate 33 through two bores 32a and 32b formed in a front piece 32c and a base 32d of the support 32 to guide movement of the member 31.

A block 35 is fixed to the rod 34 below the front piece 32c of the support 32. Coupled between the block 35 and the base 32d of the support 32 is a spring 36 which has a preselected spring constant and biases the member 31 away from the support 32. Any other resilient arrangement could be used as an alternative to the spring 36. The ease of displacement of the member 31 depends on the spring load, and is therefore adjustable by spring selection and preload.

Between the front piece 32c and the base 32d of the support 32, there is fixed to the rod 34 a high-resolution optical grating 37 which is analysed by an optical sensor 38, including an optical source and detector similar to the type of sensor used for example in ink-jet printers, fixed to the support 32. The output of the optical sensor 38 produces pulses that accurately characterise the current position and displacement of the member 31. This allows detection of changes in position over time, and instant speed information. Knowing the spring constant, displacement and the speed of the member 31, the output signal of the optical sensor 38 is representative of the force applied to the member 31.

Another advantage of the sensor 30 compared to the more classical force or pressure sensors lies in the fact that it is relatively easy to adapt mechanical properties by appropriate selection of the spring 36. This allows a simple way to fabricate the sensor 30 to work in various desired force ranges, which is not as easy with other types of sensors. For the research onto fist thump characteristics, spring selection would be guided from the expected maximum mechanical energy, to allow measurement of fist thumps in the range from 1 J to 20 J. For a training device, spring stiffness could be reduced to the recommended range of impacts, and would therefore not have to exceed 18 J, preferable 15 J, and conceivable 12 J for a single sensor implementation. Such spring selection will also make the sensation for the trainee upon impact on the target more physiological and patient-like.

The spring 36 may be selected to have mechanical properties simulating the precordial region of the chest of a human. As a result, the array of sensors 30 provides a similar reaction to that of the body, possibly including spatial differences in compressibility as they occur on the precordial chest. Furthermore, the actual deformation of the sensor plane allows the device to have a thinner cover sheet 2 or no sheet 2 at all. Optionally, the sensors 30 could include a reactive break mechanism that fixes individual members 31 in position to provide an indentation pattern for user feedback, or to control return of members 31 to their initial position to reflect chest elasticity and recoil.

The sensor 30 has another advantage that all the energy is transferred to the system during the impact, by being converted into mechanical energy and stored in the spring 36. In contrast, in the case of piezoelectric or resistance sensitive detectors, the energy is absorbed by the system.

This opto-mechanical sensor 30 allows, therefore, for the recording of the surface deformation, which is not the case with other sensor types such as piezoelectric or resistive ones, as well as to explore rate of deceleration and deceleration pathway length. In addition, initial fist impact speed can be measured without additional optical sensors, thereby simplifying the system. The above recorded parameters allow identification of pre-impact kinetic energy and deformation work in a highly dynamic setting (for example connected to standard input-output hardware for computers, sampling rates of 100 to 500 kHz are easily achievable, matching and exceeding the technical requirement for fist impact characterisation). Full characterisation of these parameters provides a principal advantage to the scientific understanding of the technique from the medical point of view, and may prove to be crucial for training purposes.

As an alternative, the sensor 30 may be modified as shown in FIG. 4. Elements in the modified version of the sensor 30 shown in FIG. 4 which are identical with the sensor 30 shown in FIG. 3 will be given the same reference numerals and a description thereof will not be repeated for brevity.

In the modified version of the sensor 30 shown in FIG. 4, spring 36 is replaced by two separate springs 70 and 71 of different spring constant. The first spring 70, which has a similar stiffness to the spring 36 in the sensor 30 shown in FIG. 3, is coupled to the base 32d of the support 32, and to a collar 72 disposed around the rod 34. However the collar 72 is separated from the block 35 by a gap 73. The second spring 71, which is less stiff than the first spring, is disposed inside the collar 72 and is coupled between the collar 72 and the block 35. As a result of this arrangement, when the member 31 moves it initially engages the second spring 71 without engaging the first spring 72. As the first spring 70 is stiffer than the second spring 71, the second spring 71 compresses without the first spring 70 compressing. After an amount of movement equal to the width of the gap 73, the member 31 engages the collar 72 directly and hence engages the first spring 70.

As the second spring 71 is less stiff than the first spring, then before the first spring 72 engages, the movement which is sensed by the optical sensor 38 provides an estimate of the speed of the fist when it initially impacts the plate 33. Preferably, the second spring 71 is sufficiently compliant as not to significantly affect the movement of the fist. This may be achieved by selection of the stiffness of the second spring 71 relative to the stiffness of the first spring 70. Preferably, the stiffness of the second spring 71 is at least an order of magnitude less than the stiffness of the first spring 70. Preferably, the stiffness of the second spring 71 is just sufficient for the second spring 71 to lift the member 31 against gravity to its pre-impact position.

Once the first spring 70 is engaged, the movement which is sensed by the optical sensor 38 provides a measurement of the applied force, as described above for the sensor 30 shown in FIG. 3.

The modified version of the sensor 30 shown in FIG. 4 has the advantage that the optical transmitter/receiver pairs 4 may be omitted. The predetermined amount of movement is preferably at least 0.5 mm, more preferably at least 1 mm. The predetermined amount of movement is preferably at most 3 mm, more preferably at most 2 mm.

The electronic circuit of the device will now be described. The electronic circuit may be powered by a battery or accumulator (not shown) or may have a socket to receive mains power for an internal low voltage power supply.

The sensors 1 are divided into groups, each group having an electronic block 41 as illustrated in FIG. 5. Each electronic block 41 (excluding the sensors 1) is formed on one of the electronic block printed circuit boards 6. The electronic blocks 1 are each arranged as follows.

A respective amplifier 42 is connected to receive and amplify the output signal of each sensor 1. The outputs of all the amplifiers 42 are supplied to a multiplexer 43 to form a functional unit. The multiplexer 43 time-division multiplexes the output signals of the group of sensors 1. An analog-to-digital converter 44 is connected to the output of the multiplexer 43 to perform analog-to-digital conversion of the multiplexed output signals.

The output of the analog-to-digital converter 44 is supplied to a block micro-controller 45 which performs various control functions and supplies the multiplexed output signals to an input/output (I/O) bus 46 connected to a bus line 52 common to all the electronic blocks 52 as shown in FIG. 6 and described in more detail below.

Most currently available force sensors are based on a variation of their resistance or the variation in a resistor bridge arrangement. The output signal of a sensor 1 is therefore obtained using a highly stabilised voltage or a current source and a voltage or current amplifier. The analog-to-digital converter 44 is chosen to provide sufficient conversion speed. Grouping the readout of a group of several sensors 1 into one single converter 44, through the use of a built-in analog multiplexer 43, ensures a greater homogeneity of measurements. In addition, it improves the ease of adjustment and calibration procedures, via the micro-controller 45 and I/O bus 46. It furthermore simplifies overall electronics design and allows the reduction of power consumption. This later aspect is of particular importance if the device is to be portable and battery-powered. The number of sensors 1 in the group is primarily dependent on the conversion speed of the analog-to-digital converter 44 and the requirements of the experiment conducted with the device.

The conversion electronics is implemented using a standard commercially available micro-controller 45 with fast analog multipled inputs, and on-chip random access memory (RAM) for data buffering, as well as an on-chip read-only-memory (ROM) for the storage of the software code.

The electronic blocks 41, one of which is illustrated in FIG. 5, are integrated as shown in FIG. 6 with the master control board 11 on which is formed a main micro-controller 53. The main micro-controller 53 receives, stores and processes the multiplexed output signals of the sensors 1 of each electronic block 41 by communication with the block micro-controllers 45 over the common bus line 52. The processing of the output signals is triggered by the output of the receiver/transmitter pairs 4 which is connected to the main micro-controller 53. Use of the output of the receiver/transmitter pairs 4 as such a trigger for data acquisition allows the data buffer size of the main micro-controller 53 to be minimised. Alternatively, triggering could occur based on the output signals themselves but this requires a larger buffer size and a greater power consumption because the output signals are continuously monitored.

The output signals are stored in an on-chip RAM of the main micro-controller 53. The other processing performed by the main micro-controller 53 is as follows.

The main micro-controller 53 supports data storage and communication of all required information, either with external devices such as a computer, or to a dedicated miniature display 56 on the housing 1 of the device itself. The display 56 will mainly be used for training in stand-alone mode of the device. The display 56 will show, for example, ‘OK-or-VOID’ indicators to illustrate whether the impact was on-centre; a colour-coded LED output of key impact parameters such as peak force, peak pressure, total force, total pressure, energy of impact, pre-impact speed, etc; or alternatively an alpha-numeric display with simple graphics ability.

The main micro-controller 53 summarises data input from individual electronic blocks and allows pre-processing of the data to display, on the display 56, characteristics of the impact and an instant OK-VOID reading regarding the impact placement relative to the centre of the sensor array.

The device may also be used as a stand-alone device. The requirement for a stand-alone systems is that it provides instant user feedback on key impact parameters, such as whether the impact occurred in the target region of the device and a classification of the impact parameters according to predetermined criteria. For example, the impact may be classified as too weak, forceful enough, or too powerful as judged by a range of user-definable parameters, such as average or peak force, average or peak pressure, energy of impact, pre-impact speed and deceleration characteristics.

The feedback information is delivered to the user in the form of simple light signals (red/yellow/green LEDs), and/or in the form of sound such as simple speech synthesis. Alternatively a small alpha-numerical LCD display may be used, which would fulfil most of the functionalities described above, and which will add the possibility to display simple graphical representation of the output signals sensors 1, such as shown in FIG. 2.

In contrast, an external computer interface will allow for more complicated tasks and analyses, including calculation of the total work performed during the manual thump and statistical comparisons. The output signals can be fed to an output port 7 (also shown in FIG. 1) which may be, for example, RS-232, USB or Ethernet-type connectors. This provides for transfer of the output signals to an external computer 60 which may be connected to the output port 7. The external computer 60 may be a conventional personal computer storing a program which is capable, on execution, of performing further data processing for analysis of the output signals, as described below. The I/O path through the output port 7 is also used for electronic calibration and tuning of the device 1 without requiring physical access to the interior of the housing 1.

The computer interfacing of the electronic circuit facilitates collection of large numbers of temporal data points of the output signals of the individual sensors 1 during the event of an impact. The active period of the event starts with the trigger signal, collected from the transmitter/receiver pairs 4, and ends at a user-selectable predefined time afterwards. The default length of the collection sequence may be determined experimentally. This has been done to date by measurements made using a digital sampling oscilloscope, which show that the transfer of energy from a fist impact lasts less than 100 ms, reaches its peak within less than 10 ms, often in less than 5 ms, while the impact tends to be completed within several tens of ms, usually no more than 20 ms. The interfacing with an external computer 60 may use a serial link (RS-232 standard), USB or Ethernet standard in order to be compliant with the industry standards available on many computers. The software of the main micro-controller 53 will transfer all the data of the output signals of the sensors 1 to the external computer 60 for further analysis. This software will also provide some extra routines for standard calibration tests and the establishment of a correction matrix to compensate for the individual detector static responses.

The external computer 60 provides a computer program to perform the following functions. In general, the computer program allows the user to extract and analyse information from the output signals of the sensors 1. This analysis is intended to provide information allowing a detailed quantification and comparison of different operators and other clinically relevant research. The practical user interface provides the user with the ability to annotate, set-up, protocol and view a video information of the impact.

In particular, the computer program provides a graphical user interface operating through a number of different windows displayed on the display of the external computer 60. Various windows of a first interface 61 are illustrated in FIG. 7 and of a second interface 62 are illustrated in FIG. 8. Both interfaces 61 and 62 allow the user to input commands and controls via the normal input means (e.g. keyboard, mouse) of the external computer 60, to control the operation of both the device and the data processing performed by the external computer 60, and also to control the analysis of the output signals of the sensors 1 to extract useful parameters.

The first graphical user interface 61 shown in FIG. 7 includes the following windows.

Through a set-up window, the operation of the device may be controlled. Inputs of the user through the set-up window may be used to develop control signals for the main micro-controller 53 of the device via the port 7.

Using a protocol window, the user may input data to be stored in association with the data of the output signals from the sensors 1. For example, as illustrated in FIG. 7, this data may include fields to identify a given thump, together with specific comments, which might include subjective views from the person making the manual thump about the perceived nature of that thump.

In a real-time display window, a graphical representation of the output signals of the sensors 1 is displayed. In particular, the representation of the output signal of each sensor 1 over time is displayed in a respective cell of a grid, the position of the cell corresponding to the positions of the respective sensor 1 in the array on the device. The real-time display also allows display of the overall force provided by the combination of the output signals of all the sensors 1 over time. The real-time display window also allows the display of other parameters derived by the computer program from the output signals. In general, the parameters may be any mechanical characteristic. Suitable parameters include the total work performed during the manual thump, the maximum force, the overall period of the impact, the time taken for the impact to reach the maximum force, and the average or median rate of change of force during the rise and fall of the impact. The real-time display window may allow the user to define other impact parameters for display.

In an off-line window, there is displayed a three-dimensional graph of the spatial distribution of the output signals of all sensors at a given time. The graph may be played as a movie to view the overall development of the impact over time.

Both the real-time display window and the off-line display window allow visualisation of the spatial distribution of the applied force.

The second graphical user interface 61 shown in FIG. 8 includes the following windows.

In a first window A, the user can set file path instructions and vary the sample rate and the number of samples.

In a second window B, a graph of the applied force over time is displayed and recordings can be transferred between display and storage using the open or save buttons (the read process can be stopped, and the device armed/de-armed using additional related functions).

In a third window C, real-time analysis of key mechanical parameters is displayed numerically (for the parameters work, maximum displacement of platform, time to peak, time from peak to baseline) and graphically (for the parameters initial impact speed, maximum force developed, and work performed during the impact which is the integral of the force/time graph).

In a fourth window D, the adjustments to sample length for initial speed measurement, threshold, input and trigger functions may be made, and the spring constant is shown for reference.

1. A device for analysing manual thumps applied to simulate pre-cordial thumps for the treatment of a dysrhythmia of the heart of a patient,
the device comprising a sensor arrangement arranged to detect parameters of a said manual thump.

2. A device according to claim 1, wherein the sensor arrangement comprises at least one sensor having a frequency response of at least 1 kHz.

3. A device according to claim 1, wherein the sensor arrangement comprises at least one sensor which produces an output signal representative of the force applied to the sensor.

4. A device according to claim 3, wherein the output of sensor arrangement is proportional to the mechanical input.

5. A device according to claim 1, wherein the sensor arrangement is arranged to detect parameters of a said manual thump having an energy in the range from 1 J to 20 J.

6. A device according to claim 1, wherein the sensor arrangement comprises at least one sensor which comprises:
a support;
a member for receiving an applied force mounted for movement relative to the support with a resilient arrangement having a preselected spring constant coupled between the member and the support; and
an optical sensor arranged to detect the displacement of the member relative to the support.

7. A device according to claim 6, wherein the optical sensor is fixed to one of the support and the member, an optical grating being fixed to the other of the support and the member positioned to be analysed by the optical sensor to detect the displacement of the member relative to the support.

8. A device according to claim 1, further comprising a speed detector arrangement for detecting the pre-impact speed of the fist.

9. A device according to claim 8, wherein the speed detector arrangement comprises at least two, spaced apart optical transmitter/receiver pairs for detecting passage of the fist.

10. A device according to claim 1, wherein the device has, in the target region for manual thumps, mechanical properties selected to simulate the precordial region of the chest of a patient.

11. A device according to claim 10, further comprising a flexible sheet covering the sensor arrangement and having a resilience selected to simulate the precordial region of the chest of a patient.

12. A device according to claim 1, further comprising analysis means for analysing the detected parameters according to predetermined criteria to classify the effectiveness of a manual thump.

13. A device according to claim 1, further comprising indicator means for outputting at least one of a visible or an audible indication of the detected parameters.

14. A device according to claim 1, wherein the sensor arrangement comprises an array of sensors.

15. A device according to claim 14, wherein the array is a regular array.

16. A device according to claim 14, wherein each sensor is covered by a rigid cap for transmitting applied force to the respective sensor.

17. A device according to claim 14, further comprising an electronic circuit for receiving the output signal of each sensor.

18. A device according to claim 17, wherein the electronic circuit comprises at least one analog-to-digital converter arranged to convert the output signals of the sensors into a digital signal.

19. A device according to claim 18, wherein the electronic circuit further comprises at least one multiplexer arranged to time-division multiplex the output signals of a group of sensors before conversion by said at least one analog-to-digital converter.

20. A device according to claim 19, comprising a plural number of multiplexers and analog-to-digital converters, each arranged to convert the output of a respective multiplexer.

21. A device according to claim 1, wherein the device has an output port for transferring the output signals of the sensor arrangement.

22. A combination of a device according to claim 1 with a computer system arranged to receive the output signals of the sensor arrangement, the computer system having a computer program executable to process the output signals of the sensor arrangement.

23. A combination according to claim 22, wherein the computer program capable of deriving the work performed during the manual thump.

24. A combination according to claim 22, wherein the computer program is capable of producing a graphical representation of the output signals of the sensors.

25. A combination according to claim 24, wherein the computer program is capable of producing a graphical representation of any one or all of: the respective output signal of respective sensors over time; the combination of the output signals of all the sensors over time; and the output signals of the sensors in their relative positions.

26. A method of analysing a manual thump applied to stimulate a pre-cordial thump for the treatment of a dysrhythmia of the heart of a patient, comprising applying the manual thump to a device according to claim 1.

27. A force-detecting sensor comprising:
a support;
a member for receiving an applied force mounted for movement relative to the support with a resilient arrangement having a preselected spring constant coupled between the member and the support; and
an optical sensor for detecting the displacement of the member relative to the support, the detected displacement being representative of the applied force.

28. A sensor according to claim 27, wherein the optical sensor is fixed to one of the support and the member, and an optical grating is fixed to the other of the support and the member in a position to be analysed by the optical sensor to detect the displacement of the member relative to the support.

29. A computer program executable by a computer system and capable, when so executed, of causing the computer system to process the output signals of an array of sensors arranged to detect an impact applied thereto.

30. A computer program according to claim 29, wherein the computer program is capable of causing the computer system to produce a graphical representation of the output signals of the sensors.

31. A computer program according to claim 30, wherein the computer program is capable of causing the computer system to produce a graphical representation of any one or all of: the respective output signal of respective sensors over time; the combination of the output signals of ail the sensors over time; and the output signals of the sensors in their relative positions.

32-54. (canceled)
